(19) United States
(12) Patent Application Publication
(10) Pub. No.: US 2010/0282802 A1
(43) Pub. Date: Nov. 11, 2010

(54) Flashlight holder mounted in a vehicle console

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 12/387,786

(22) Filed: May 7, 2009

(51) Int. Cl. B60R 7/04; B23P 11/00

(52) U.S. Cl. 224/539; 224/545; 29/525.02

(57) ABSTRACT

A flashlight holder for mounting in a vehicle, wherein a vehicle console is provided having a console frame formed of opposing side panels interconnected between opposing end panels, and a plurality of console face plates each having portions thereof securable with at least one of the side panels. A flashlight holder is formed of a lengthwise tubular receptacle having a mouth thereinto that is sized to receive a flashlight there through, and a stop positioned opposite from the mouth. Means are provided for securing the tubular receptacle to the vehicle console with the mouth positioned vertically above the stop.

### FIELD OF THE INVENTION

The present invention relates to vehicle consoles being mountable within a vehicle driver compartment to support equipment in a location easily accessible to a driver of the vehicle, and in particular to such a vehicle console safe and convenient means for mounting of a standard police-issue flashlight.

### BACKGROUND OF THE INVENTION

Police officers, public safety officers, firefighters, paramedics and the like carry various types of equipment in their vehicles. Several pieces of equipment are often carried in a single vehicle, and the driver often needs to operate the equipment while simultaneously driving the vehicle. Thus, various devices exist to secure multiple pieces of equipment within a vehicle so that they are accessible to the driver and/or other persons in the vehicle driver compartment.

These devices commonly include a hollow rectangular box situated on the floor of the vehicle between the driver seat and front passenger seat, including a horizontal top portion having an upwardly facing opening for receiving pieces of equipment. Police cruisers, for example, are commonly fitted with equipment boxes of this type. The boxes are used to house various types of equipment and controls used by police officers, such as radios, siren controls and light bar controls. Typically, the boxes are sized and positioned so that most of the box extends between the driver seat and the front seat. Only a small portion, if any, of the box will extend forward toward the dashboard beyond the driver seat and front passenger seat. In some police cruisers, the equipment box extends all the way back to the prisoner partition separating the rear seating area from the driver compartment. A laptop computer is often positioned between the box and dashboard, and is secured to the vehicle floor with various types of mounting hardware.

The conventional equipment box configuration described above fails to provide safe and convenient means for mounting of a standard police-issue flashlight.

### SUMMARY OF THE INVENTION

The present invention is a flashlight holder for mounting in a vehicle console, wherein a vehicle console is provided having a console frame formed of opposing side panels interconnected between opposing end panels, and a plurality of console face plates each having portions thereof securable with at least one of the side panels. A flashlight holder is formed of a lengthwise tubular receptacle having a mouth thereinto that is sized to receive a flashlight there through, and a stop positioned opposite from the mouth. Means are provided for securing the tubular receptacle to the vehicle console with the mouth positioned vertically above the stop.

According to one aspect of the novel flashlight holder, the flashlight holder is provided by a fishing rod holder.

According to another aspect of the novel flashlight holder, a method is provided of mounting a flashlight holder in a vehicle console, wherein a console frame having opposing side panels interconnected between opposing end panels is mounted in a vehicle. A face plate is mounted in the console frame, which includes securing portions of the face plate with at least one of the side panels. A flashlight holder is mounted in the vehicle console, wherein a mouth of the flashlight holder communicating with a tubular receptacle thereof and sized to receive a flashlight thereinto is positioned vertically above a stop thereof The flashlight holder is secured to the vehicle console. For example, securing the flashlight holder to the vehicle console includes clamping the flashlight holder to the vehicle console. One means of clamping the flashlight holder to the vehicle console includes threadedly fastening the flashlight holder within the face plate, such as by coupling a U-bolt into a socket portion of the vehicle console.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of a novel flashlight holder;

FIG. 2 is a perspective bottom view showing mounting of the flashlight holder; and

FIG. 3 is a cross-section view showing mounting of the flashlight holder.

### DETAILED DESCRIPTION OF PREFERRED EMBODIMENT

In the Figures, like numerals indicate like elements.

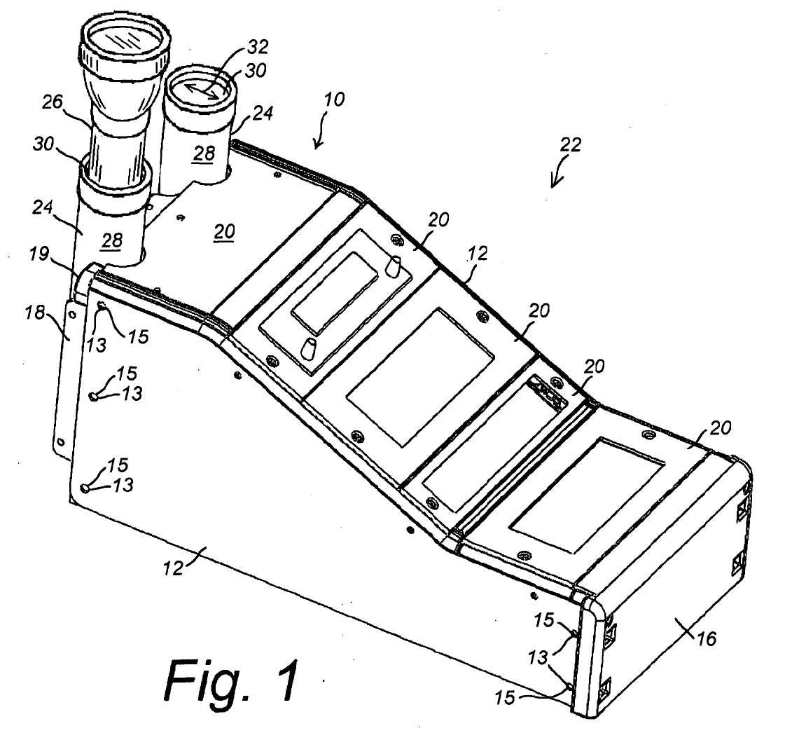

FIG. 1 is a perspective view that illustrates a novel reconfigurable vehicle console 10 having a pair of opposing substantially rigid side panels 12 and opposing substantially rigid end panels 16 and 18. End panels 16, 18 are substantially rigidly interconnected between side panels 12 at one or more cooperating connection points 13 by means of connectors 15. End panels 16, 18 and side panels 12 thereby forming a substantially rectangular support frame 19. A plurality of substantially interchangeable face plates 20 are removably clamped to side panels 12 of the rectangular support frame 19 between the opposing end panels 16, 18 to form a top or upwardly facing surface 22 of console 10.

One or a pair (shown) of flashlight holders 24 are mounted on console 10. For example, flashlight holders 24 are sized to receive a standard police-issue flashlight 26. However, flashlight holders 24 are optionally sized to receive a conventional flashlight, without deviating from the scope and intent of the present invention. As illustrated, according to one embodiment, flashlight holders 24 are optionally provided by a pair of substantially cylindrical tubular fishing rod holders. As further illustrated, flashlight holders 24 are optionally mounted within or as part of face plate 20 of vehicle console 10.

Each flashlight holder 24 is an open tubular receptacle 28 formed of a substantially rigid material with a longitudinal axis and having a mouth opening 30 thereinto. Tubular receptacle 28 is substantially cylindrical with a substantially constant or slightly flared inner diameter 32 sized to slidingly receive flashlight 26. Mouth opening 30 is positioned vertically above tubular receptacle 28, whereby flashlight holder 24 is positioned in a substantially upright orientation.

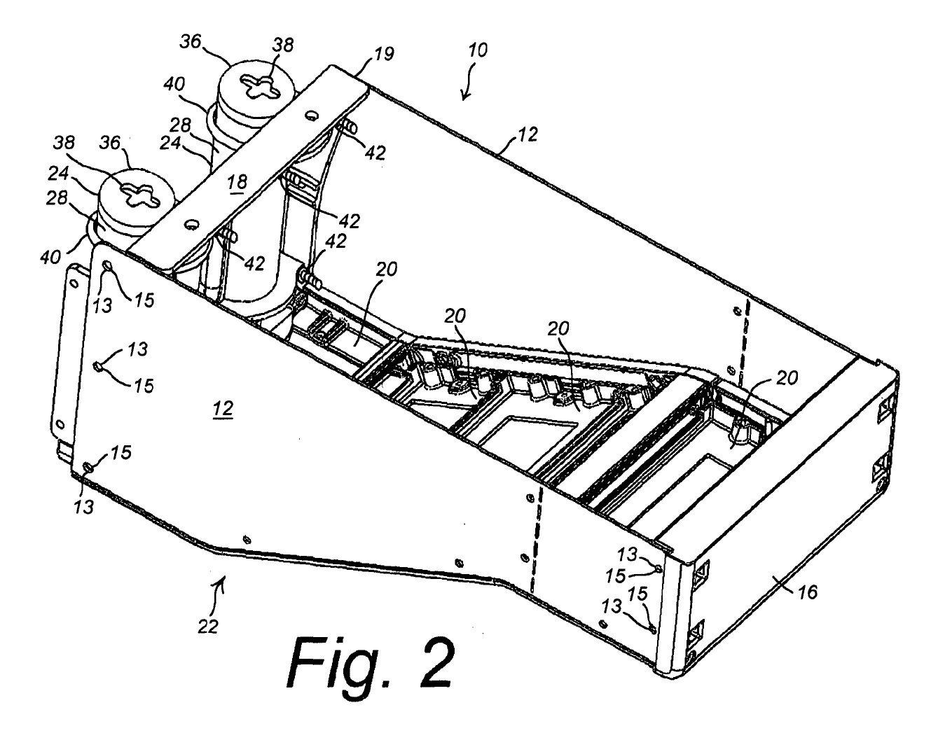

FIG. 2 illustrates receptacle 28 of flashlight holder 24 as being optionally substantially closed by, for example, an end cap 36 opposite from opening 30. End cap 36 is either molded with receptacle 28 or added separately thereto. An optional drain 38 in or near end cap 36 maintains dry conditions within receptacle 28. Each flashlight holder 24 is mounted with opening 30 positioned vertically above end cap 36 which doubles as a stop for flashlight 26. Else, flashlight holder 24 is open at its nether end 34, and opening 30 operates as a collar for supporting the illumination head of flashlight 26. In either open or closed-end configuration, flashlight holder 24 thus operates as a gravity tube for retaining flashlight 26.

Optionally, a clamp 40 secures flashlight holders 24 to vehicle console 10 in their substantially upright orientation with opening 30 positioned vertically above end cap 36. For example, the clamp 40 is one or a pair of threaded fasteners, such as conventional U-bolts (shown), which secure each flashlight holder 24 to mating sockets 42 of vehicle console 10.

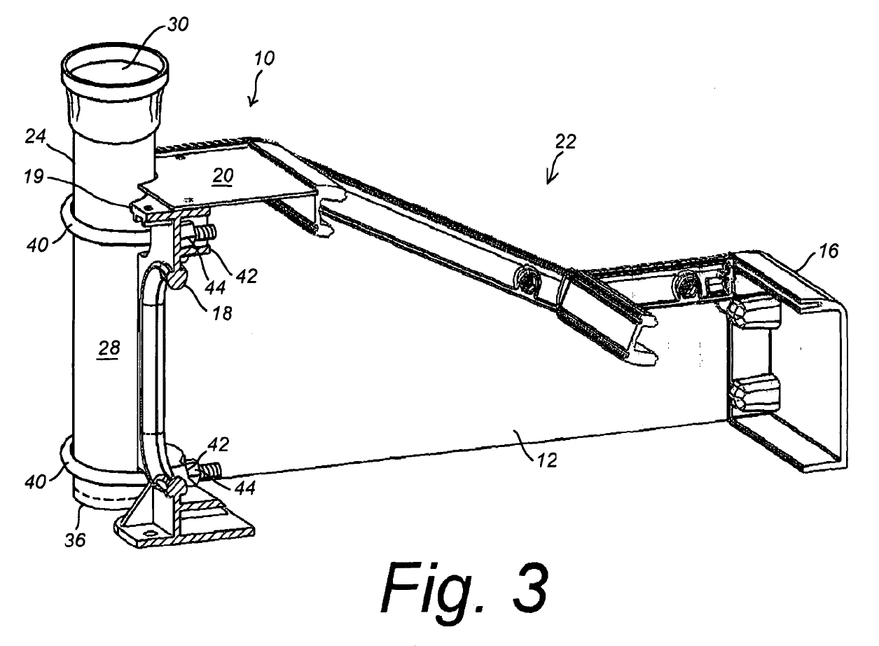

FIG. 3 illustrates clamps 40 securing flashlight holders 24 to vehicle console 10 with mouth opening 30 positioned vertically above receptacle 28. Here, clamps 40 are shown by example and without limitation as conventional threaded U-bolts secured to mating sockets 42 by matching nuts 44. For example, two U-bolt clamps 40 are extended through end panel 18 into mating sockets 42 and secured by nuts 44. Sockets 42 are optionally molded into end panel 18.

### Method

Vehicle console 10 is mounted in a vehicle by mounting console support frame 19 is mounted in the vehicle with side panels 12 interconnected between opposing end panels 16, 18 by means of connectors 15 at one or more cooperating connection points 13. One or more face plates 20 are mounted in vehicle console 10 by securing portions thereof with at least one of the side panels 12, face plates 20 forming top or upwardly facing surface 22 of console 10.

One or more flashlight holders 24 are provided, for example by conventional tubular fishing rod holders.

According to one embodiment, one or more flashlight holder 24 are mounted in substantially upright orientation in vehicle console 10 by positioning mouth opening 30 vertically above tubular receptacle 28 and securing flashlight holder 24 to vehicle console 10. Flashlight holder 24 is secured in vehicle console 10 by clamping thereto. By example and without limitation, clamping flashlight holder 24 to vehicle console 10 is accomplished by threadedly fastening flashlight holder 24 adjacent to or within one face plate 24. Optionally, threadedly fastening flashlight holder 24 to vehicle console 10 is accomplished by coupling one or a pair of U-bolt clamps 40 into mating sockets 42 of vehicle console 10 and secured with matching nuts 44.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A flashlight holder for mounting in a vehicle console, comprising:
a tubular receptacle comprising a mouth sized to receive a flashlight there through; and
means for mounting the receptacle in a vehicle with the mouth positioned vertically above the tubular receptacle.

2. The flashlight holder of claim 1 wherein the tubular receptacle further comprises substantially cylindrical receptacle comprising a substantially constant inside diameter.

3. The flashlight holder of claim 2 wherein the tubular receptacle further comprises a stop positioned opposite from the mouth.

4. The flashlight holder of claim 2 wherein the tubular receptacle further comprises a fishing rod holder.

5. The flashlight holder of claim 2, further comprising a vehicle console, comprising:
a console frame comprising two opposing side panels and two opposing end panels; and
a face plate comprising portions thereof securable with a respective one of the side panels; and
further comprising a means for securing the tubular receptacle to the console.

6. The flashlight holder of claim 5 wherein the means for securing the tubular receptacle to the console further comprises a clamp.

7. The flashlight holder of claim 6 wherein the clamp further comprises a threaded fastener coupling the tubular receptacle into the vehicle console.

8. The flashlight holder of claim 7 wherein the threaded fastener further comprises a U-bolt coupled into a socket.

9. A flashlight holder for mounting in a vehicle console, comprising:
a vehicle console, comprising:
a console frame comprising opposing side panels interconnected between opposing end panels, and
a plurality of console face plates each comprising portions thereof securable with at least one of the side panels;
a lengthwise tubular receptacle comprising a mouth thereinto and sized to receive a flashlight there through, and a stop positioned opposite from the mouth; and
a means for securing the tubular receptacle to the vehicle console with the mouth positioned vertically above the stop.

10. The flashlight holder of claim 9 wherein the tubular receptacle further comprises a substantially cylindrical receptacle comprising a substantially constant inside diameter communicating with the mouth.

11. The flashlight holder of claim 10 wherein the stop further comprises a closed end of the receptacle.

12. The flashlight holder of claim 11 wherein the tubular receptacle further comprises a fishing rod holder.

13. The flashlight holder of claim 11 wherein the means for securing the tubular receptacle to the console further comprises a clamp.

14. The flashlight holder of claim 13 wherein the clamp further comprises a threaded fastener coupling the tubular receptacle within one of the plurality of console face plates.

15. The flashlight holder of claim 14 wherein the threaded fastener further comprises a U-bolt coupled into a socket.

16. A method of mounting a flashlight holder in a vehicle console, comprising:
in a vehicle console, mounting a console frame comprising opposing side panels interconnected between opposing end panels;
mounting a face plate in the vehicle console, wherein mounting the face plate further comprises securing portions thereof with at least one of the side panels;
mounting a flashlight holder in the vehicle console, wherein mounting the flashlight holder further comprises positioning a mouth communicating with a tubular receptacle thereof and sized to receive a flashlight thereinto vertically above a stop thereof; and
securing the flashlight holder to the vehicle console.

17. The method of claim 16 wherein securing the flashlight holder to the vehicle console further comprises clamping the flashlight holder to the vehicle console.

18. The method of claim 17 wherein clamping the flashlight holder to the vehicle console further comprises threadedly fastening the flashlight holder within the face plate.

19. The method of claim 18 wherein threadedly fastening the flashlight holder within the face plate further comprises coupling a U-bolt into a socket portion of the vehicle console.

20. The method of claim 19 wherein mounting a flashlight holder in the vehicle console further mounting a fishing rod holder.
